(19) United States
(12) Patent Application Publication
(10) Pub. No.: US 2013/0346991 A1
(43) Pub. Date: Dec. 26, 2013

(54) METHOD OF CONTROLLING INFORMATION PROCESSING APPARATUS, AND INFORMATION PROCESSING APPARATUS

(71) Applicant: FUJITSU LIMITED, Kawasaki-shi (JP)

(72) Inventor: Takeo MURAKAMI, Kawasaki (JP)

(73) Assignee: FUJITSU LIMITED, Kawasaki-shi (JP)

(21) Appl. No.: 13/868,437

(22) Filed: Apr. 23, 2013

(30) Foreign Application Priority Data
Jun. 22, 2012 (JP) 2012-140453

(51) Int. Cl. G06F 9/48

(52) U.S. Cl. CPC G06F 9/4881
USPC 718/102

(57) ABSTRACT

A method of controlling an information processing apparatus includes detecting a first application program of which an execution result is displayed, obtaining a parameter correlating to the first application program, and determining, by a processor, the number of cores to be run in a CPU on a basis of the parameter.

### CROSS-REFERENCE TO RELATED APPLICATION

This application is based upon and claims the benefit of priority of the prior Japanese Patent Application No. 2012-140453, filed on Jun. 22, 2012, the entire contents of which are incorporated herein by reference.

### FIELD

The embodiments discussed herein are related to a method of controlling an information processing apparatus, a medium, and an information processing apparatus.

### BACKGROUND

In accordance with improved performance and multiple functions of portable terminal apparatuses, there is demand for improvement to the processing capability of a CPU. In order to improve the processing capability of a CPU, for example the operating frequency of the CPU may be increased. However, when the operating frequency of the CPU is increased, power consumption increases significantly. Therefore, recently portable terminal apparatuses tend to have a CPU housing multiple cores, i.e. a multi-core CPU, built in, so as to increase the processing capability of the overall CPU. If the number of cores of the CPU is increased and operated at a low frequency, similar CPU processing capability may be obtained with less power consumption than the case of increasing the operating frequency of the CPU.

A multi-core CPU has a combination of multiple operable operating frequencies and voltage, and according to the usage state of the portable terminal apparatus, switches between operating frequency and voltage, thereby controlling operating speed and power consumption. In recent portable terminal apparatuses that are operated by various types of applications, such multi-core CPU features are utilized to automatically control the CPU according to the usage state, and secure operating functionality as seen by the user and reduction of power consumption.

Now, in order to actively control a multi-core CPU, the operating frequency of the running core is raised in accordance with the CPU load increasing while measuring the CPU load, and in the case that the CPU processing capability is still insufficient, the number of running cores of the multi-core CPU is increased.

At this time, if the CPU load suddenly increases resulting from operations by the application program that a user is operating, the timing to increase the number of running cores may be delayed, and may influence the user operation and screen display of the application program. For example, if the CPU load is suddenly increased resulting from screen scrolling by the user, continuous scrolling is not performed, which may be perceived by the user as being sluggish.

In order to avoid the delay in such core startup, the number of running cores may be increased early, before the CPU processing capability becomes insufficient, for example. However, even if the running core is increased before the CPU processing capability becomes insufficient, if the CPU load does not suddenly increase, the core that has been started up in advance ends up idle, and increases power consumption unnecessarily.

Disclosed in Japanese Laid-open Patent Publication Nos. 2007-334782, 2008-129846, and 2010-271930 are examples of related art.

### SUMMARY

According to an aspect of the invention, a method of controlling an information processing apparatus including detecting a first application program of which an execution result is displayed, obtaining a parameter correlating to the first application program, and determining, by a processor, the number of cores to be run in a CPU on a basis of the parameter.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of a hardware configuration of a portable terminal apparatus according to a first embodiment;

FIG. 2 is a schematic diagram of a functional block of a portable terminal apparatus according to the first embodiment;

FIG. 3 is a schematic diagram of application/service operation information according to the first embodiment;

FIG. 4 is a schematic diagram of application CPU core control information according to the first embodiment;

FIG. 5 is a schematic diagram of CPU control information according to the first embodiment;

FIG. 6 is a schematic diagram of system state information according to the first embodiment;

FIG. 7 is a schematic diagram of process operation information according to the first embodiment;

FIG. 8 is a flowchart of CPU core control processing according to the first embodiment;

FIG. 9 is a flowchart of application coordinating control processing according to the first embodiment;

FIG. 10 is a flowchart of a one-core operating process according to the first embodiment;

FIG. 11 is a flowchart of a multiple-core operating process according to the first embodiment;

FIG. 12 is a flowchart of application operation monitoring processing according to the first embodiment;

FIG. 13 is a flowchart of load threshold value correcting processing according to the first embodiment;

FIG. 14 is a schematic diagram of a functional block of a portable terminal apparatus according to a second embodiment;

FIG. 15 is a schematic diagram of a steady load managing table according to the second embodiment;

FIG. 16 is a flowchart of application coordinating control processing according to the second embodiment;

FIG. 17 is a flowchart of a one-core operating process according to the second embodiment;

FIG. 18 is a flowchart of a multiple-core operating process according to the second embodiment; and

FIG. 19 is a flowchart of steady load monitoring processing according to the second embodiment.

### DESCRIPTION OF EMBODIMENTS

### First Embodiment

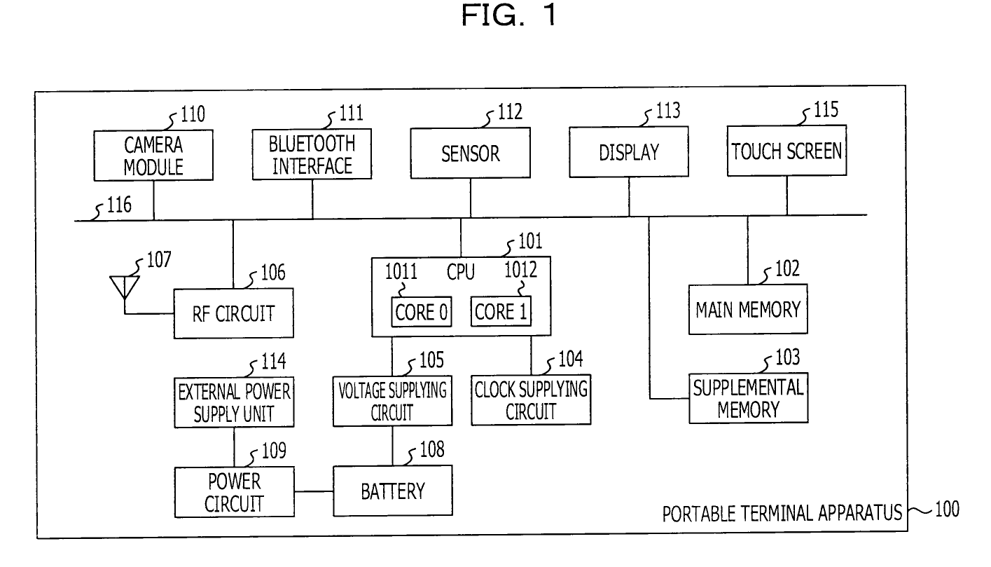

A portable terminal apparatus 100 as an information processing apparatus according to a first embodiment will be described below with reference to FIGS. 1 through 13. Now, let us assume that Android (registered trademark) is used as the operating system (hereinafter, simply “OS”) installed in the portable terminal apparatus 100. Android includes an OS kernel and an application framework/library, and a control program according to the present embodiment is built into the application framework/library. However, an aspect of the present disclosure is not limited to this, and an OS other than Android may be used. Further, the control program according to the present embodiment may be built other than in the application framework/library.

Hardware of Portable Terminal Apparatus 100

FIG. 1 is a schematic diagram of a hardware configuration of the portable terminal apparatus 100 according to the first embodiment.

According to the first embodiment, the portable terminal apparatus 100 is assumed to be a smartphone or tablet Personal Computer (PC) or the like, for example.

As illustrated in FIG. 1, the portable terminal apparatus 100 according to the first embodiment has a Central Processing Unit (CPU) 101, main memory 102, supplemental memory 103, clock supplying circuit 104, voltage supplying circuit 105, Radio Frequency (RF) circuit 106, antenna 107, battery 108, power circuit 109, camera module 110, Bluetooth interface 111, sensor 112, display 113, external power supply unit 114, and touch screen 115 as hardware modules. The hardware modules herein are mutually connected via a bus 116.

The CPU 101 is operated by a clock signal supplied from the clock supplying circuit 104 and voltage supplied from the voltage supplying circuit 105, and controls various types of hardware modules of the portable terminal apparatus 100. The CPU 101 is a so-called dual core CPU, and has a “core 0” 1011 and “core 1” 1012. Further, the CPU 101 reads out various types of programs stored in the supplemental memory 103 and this to the main memory 102, and executes the various types of programs loaded in the main memory 102, thereby realizing various types of functions. Details of the various types of functions will be described later. The CPU 101 according to the present embodiment uses a dual core CPU, but an optional number of cores may be used, such as a quad core CPU for example.

The main memory 102 stores various types of programs executed by the CPU 101. Further, the main memory 102 is used as a work area of the CPU 101, and stores various types of data used for processing by the CPU 101. The main memory 102 may be a Random Access Memory (RAM) or the like, for example.

The supplemental memory 103 stores various types of programs to operate the portable terminal apparatus 100. The various types of programs may be an application program executed by the portable terminal apparatus 100 or an Android (OS) or the like. An application program has applications which the user may operate on screen and services that operate in the background to operate the applications, and so forth, stored therein. The control program according to the present embodiment is also stored in the supplemental memory 103. The control program is built into the application framework/library of Android. The supplemental memory 103 may use a non-volatile memory such as a hard disk or flash memory or the like, for example.

The clock supplying circuit 104 generates a clock signal to be supplied to the CPU 101. The clock supplying circuit 104 may be realized by a crystal oscillator that emits a clock signal and a real time clock (RTC).

The voltage supplying circuit 105 generates variable voltage to supply to the CPU 101, based on power supplied from the power circuit 109. The voltage supplying circuit 105 may be realized by a voltage detector and a voltage regulator.

The RF circuit 106 is controlled by a CPU 101, and transmits a high frequency signal from the antenna 107 to another wireless communication device. Further, the RF circuit 106 converts the high frequency signal received from the antenna 107 to a baseband signal, and outputs the baseband signal to the CPU 101.

The battery 108 supplies power to the power circuit 109. The battery 108 may be realized by a battery such as a lithium-ion battery and a battery protection Integrated Circuit (IC), for example.

The power circuit 109 supplies the power supplied from the battery 108 to various types of hardware modules of the portable terminal apparatus 100, via a power line (unshown). Note that in the case that an external power source (unshown) is connected to the external power supply unit 114, the power circuit 109 may supply the power supplied from the external power supply unit 114 to the various types of hardware modules of the portable terminal apparatus 100. The power circuit 109 may be realized by a switching regulator and voltage regulator, for example.

The camera module 110 is controlled by the CPU 101, and obtains imaging date of a subject. The Bluetooth interface 111 is a communication interface to execute wireless communication by Bluetooth (registered trademark) with another wireless communication device. The portable terminal apparatus 100 may further has a wireless communication interface such as a wireless LAN (Local Area Network) or the like.

The display 113 is controlled by the CPU 101, and displays image information to a user. The touch screen 115 is adhered to the display 113, and inputs position information made by contact with a fingertip or pen tip of a user. According to the present embodiment, the touch screen 115 is used as a position input device for user operations.

The sensor 112 is controlled by the CPU 101, and obtains status information of the portable terminal apparatus. The sensor 112 may be an acceleration sensor, gyro sensor, illuminance sensor, geomagnetic sensor, tilt sensor, pressure sensor, proximity sensor, temperature sensor, 3G sensor (3G module), wireless LAN, GPS (Global Positioning System) module, or the like.

Function Block of Portable Terminal Apparatus 100

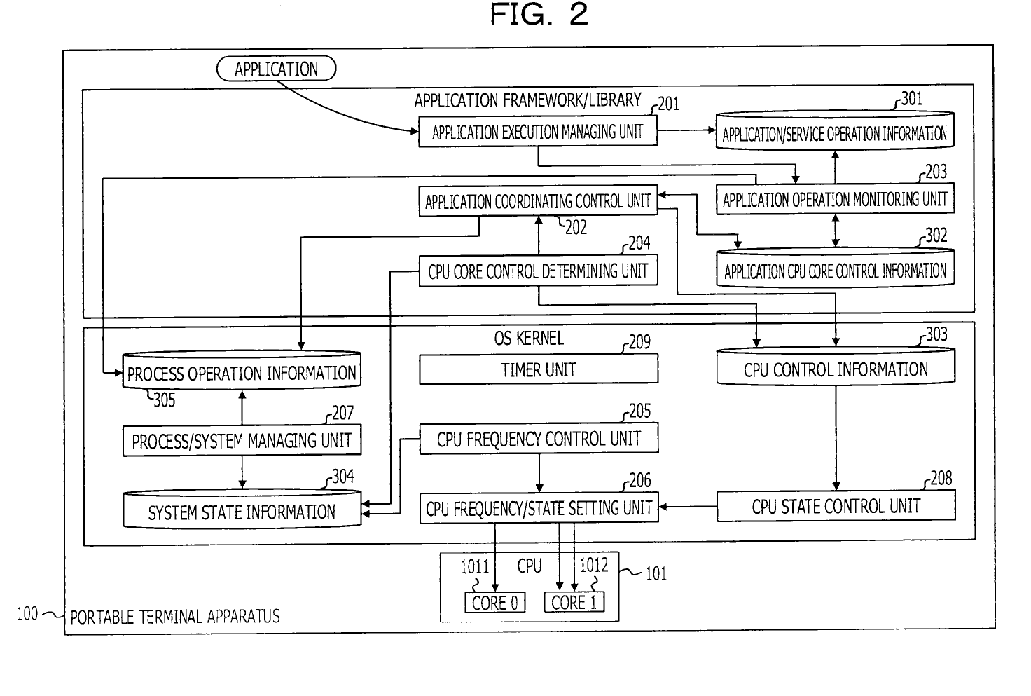

FIG. 2 is a schematic diagram of a functional block of the portable terminal apparatus 100 according to the present embodiment.

The application programs according to the present embodiment are categorized into applications and services.

An application is an application program where content (execution results) is displayed on the display 113, and where the user may perform screen operations. A service is an application program which is operated constantly in the background, based on requests from the applications.

Further, in the case that multiple applications are operating, there exist applications having an environment where content is displayed at the front of the display 113 and the user may actually perform screen operations (foreground), and applications having an environment where content is not displayed at the front of the display 113 and the user does not actually perform screen operations (background).

According to the present embodiment, an application having an environment where the user may actually perform screen operations is a foreground application and an application having an environment where the user does not actually perform screen operations is a background application. However, an application may be either a background application or foreground application, depending on the user operations, for example.

As illustrated in FIG. 2, according to the present embodiment, the portable terminal apparatus 100 has an application execution managing unit 201, application coordinating control unit 202, application operation monitoring unit 203, CPU core control determining unit 204, CPU frequency control unit 205, CPU frequency/state setting unit 206, process/system managing unit 207, CPU state control unit 208, timer unit 209, application/service operation information 301, application CPU core control information 302, CPU control information 303, system state information 304, and process operation information 305.

The application execution managing unit 201, application coordinating control unit 202, application operation monitoring unit 203, CPU core control determining unit 204, operation information 301, and application CPU core control information 302 may each be realized by the CPU 101 executing the Android application framework/library.

Of these, the application coordinating control unit 202, application operation monitoring unit 203, CPU core control determining unit 204, and application CPU core control information 302 may each be realized by the CPU 101 executing the control program built into the application framework/library.

The CPU frequency control unit 205, CPU frequency/state setting unit 206, process/system managing unit 207, CPU state control unit 208, timer unit 209, CPU control information 303, system state information 304, and process operation information 305 may each be realized by the CPU 101 executing an Android OS kernel.

Note that the application/service operation information 301, application CPU core control information 302, CPU control information 303, system state information 304, and process operation information 305 are each configured in the supplemental memory 103.

The application execution managing unit 201 manages the execution and stopping of programs such as applications and services. Specifically, in the case that a change occurs to the use environment or process state of the application programs such as applications or services, the application execution managing unit 201 updates the “type” or “state” of later-described application/service operation information 301. Foreground and background are defined as use environments. Further, in the case that the application program (app) starts an operation in the foreground, i.e. in the case of starting or restarting in the foreground, the application execution managing unit 201 transmits a foreground starting notification to the application operation monitoring unit 203. The foreground starting notification includes a process ID of the program (foreground app) that has been started or restarted in the foreground.

The application coordinating control unit 202 periodically measures the operating state of foreground app and the CPU usage rate, and based on a “load threshold value (parameter)” for each foreground app, determines whether or not to increase/decrease the core of the CPU 101. Specifically, the application coordinating control unit 202 references the application CPU core control information 302 and the process operation information 305, and computes the “most recent CPU usage rate” of the foreground app as the most recent CPU load. Further, the application coordinating control unit 202 determines ON/OFF of the “core 1” 1012, based on the “most recent CPU usage rate” and the “load threshold value” determined for each foreground app, and records “0” or “1” in the “cpu1/online (ON/OFF instructions of the CPU core) of the CPU control information 303.

Based on the foreground starting notification from the application execution managing unit 201, the application operation monitoring unit 203 changes the setting content for “monitoring target” of the application CPU core control information 302. Further, in the case that a program transitioned from foreground to background is a post-installation program, the application operation monitoring unit 203 updates “average duration” and “average CPU usage rate”, based on the “average duration”, “average CPU usage rate”, “application duration”, and “application load” recorded in the application CPU core control information 302b. Also, the application operation monitoring unit 203 corrects the “load threshold value” for each foreground app, based on the “average duration” and average CPU usage rate of the application CPU core control information 302b.

The CPU core control determining unit 204 periodically measures the operating state of the system, and determines whether or not to increase/decrease the core of the CPU 101. Specifically, the CPU core control determining unit 204 references the system state information 304, and executes a change in setting content of the “cpu1/online” of the CPU control information 303 or a callup of the application coordinating control unit 202, based on the most recent “Run_queue_avg (process waiting queue average value)” Q and the ON threshold value T_{ON} determined beforehand.

The CPU frequency control unit 205 periodically measures the system state information 304, and notifies the CPU frequency/state setting unit 206 of change instructions to the operating frequency of a running core of the CPU 101, based on the “Run_queue_avg” of the systems state information 304.

The CPU frequency/state setting unit 206 controls the ON/OFF for the “core 1” 1012 of the CPU 101, based on ON/OFF instructions from the CPU state control unit 208. Further, the CPU frequency/state setting unit 206 controls operating frequency of the running core of the CPU 101, based on change instructions to the operating frequency from the CPU frequency control unit 205.

The process/system managing unit 207 manages the operating situation of the processes executed by the CPU 101. Specifically, the process/system managing unit 207 periodically measures the operating situation of the processes executed by the CPU 101, and updates “operating state”, “user mode operating time”, and “kernel mode operating time” of the process operation information 305. Further, the process/system managing unit 207 manages the operating situation of the system. Specifically, the process/system managing unit 207 measures the operating situation of the system and updates “Online”, “Offline”, “Run_queue_avg” of the system state information 304. Measurement intervals of the process and system operating situations are not particularly limited, but for example several milliseconds to several tens of milliseconds may be used.

The CPU state control unit 208 periodically measures the CPU control information 303, and notifies the CPU frequency/state setting unit 206 of ON/OFF instructions for the “core 1” 1012, based on the “cpu1/online” of the CPU control information 303. For example, in the case that “cpu1/online” is changed from “1” to “0” when the “core 1” 1012 is ON, the CPU state control unit 208 notifies OFF instructions for the “core 1” 1012 to the CPU frequency/state setting unit 206. Conversely, in the case that “cpu1/online” is changed from “0” to “1” when the “core 1” 1012 is OFF, the CPU state control unit 208 notifies ON instructions for the “core 1” 1012 to the CPU frequency/state setting unit 206.

The timer 209 notifies the current point-in-time to the application execution managing unit 201, application coordinating control unit 202, application operation monitoring unit 203, CPU core control determining unit 204, CPU frequency control unit 205, CPU frequency/state setting unit 206, process/system managing unit 207, CPU state control unit 208, for example, based on the time information obtained from a clock circuit (unshown), for example.

Application/Service Operation Information 301

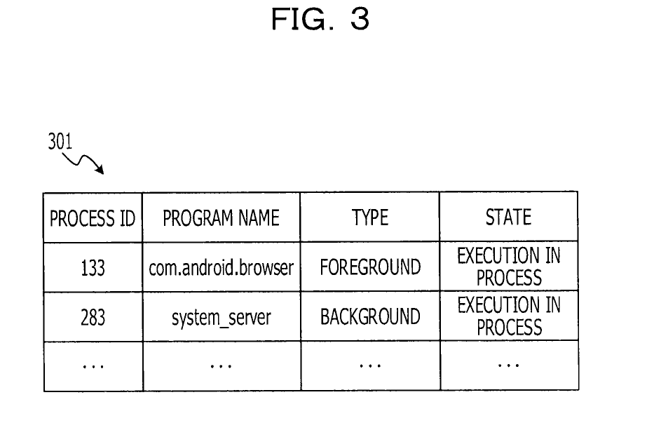

FIG. 3 is a schematic diagram of the application/service operation information 301 according to the first embodiment.

As illustrated in FIG. 3, the application/service operation information 301 stores “process ID”, “program name”, “type”, and “state” for each application program. The application/service operation information 301 stores the processes for all of the application programs executed by the CPU 101. Accordingly, the application/service operation information 301 also stores the processes for apps (foreground app, background app) and services, for example. “Foreground” and “background” are defined as “type”. “Executing”, “waiting”, “executable”, “stopped”, and “zombie” are defined as “state”. “Type” and “state” of the application/service operation information 301 are updated by the application execution managing unit 201.

Application CPU Core Control Information 302

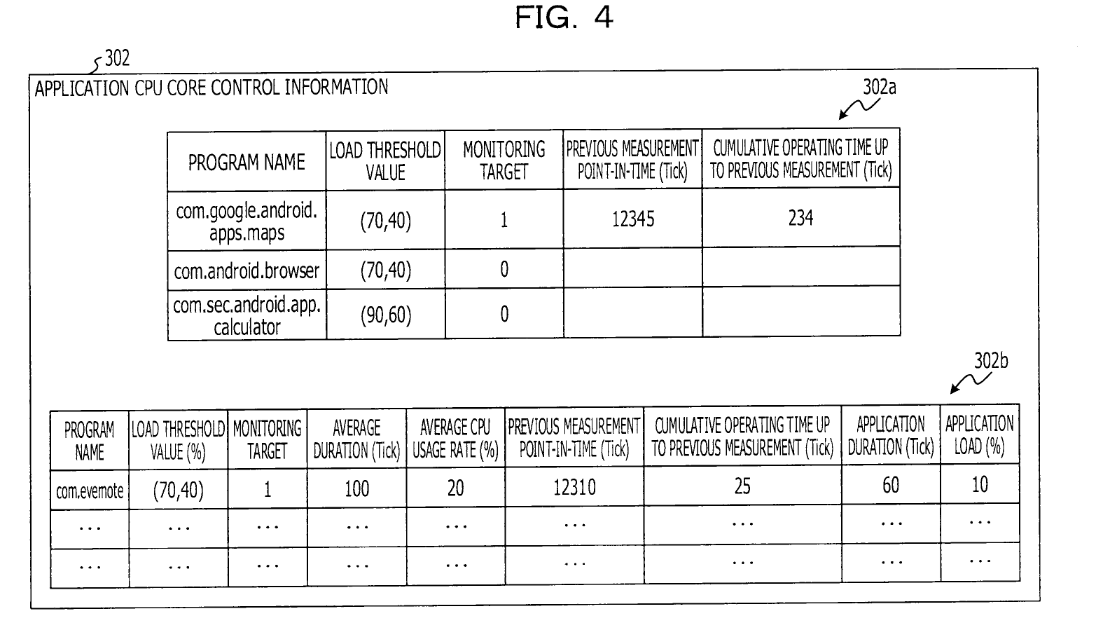

FIG. 4 is a schematic diagram of the application CPU core control information 302 according to the first embodiment.

As illustrated in FIG. 4, the application CPU core control information 302 includes an application CPU core control information 302a dedicated to applications that have been pre-installed in the portable terminal apparatus 100 (pre-installation app) and an application CPU core control information 302b dedicated to applications that have been post-installed in the portable terminal apparatus 100 (post-installation app).

For example, an application that is installed at the time of deployment of the portable terminal apparatus 100 serves as a “pre-installation program”, and an application that the user himself has installed after purchasing the portable terminal apparatus 100 serves as a “post-installation program”.

Note that according to the present embodiment, foreground apps such as a map, browser, calculator and the like are registered in the application CPU core control information 302a, and Evernote is registered in the application CPU core control information 302b.

The application CPU core control information 302a dedicated to pre-installation applications store “program name”, “load threshold value (parameter)”, “monitoring target”, “previous measurement point-in-time”, and “cumulative operating time up to previous measurement” for each application program.

“Load threshold value” includes an ON threshold value (first load threshold value) used for turning ON the “core 1” 1012 of the CPU 101, and an OFF threshold value (second load threshold value) used for turning OFF the “core 1” 1012 of the CPU 101. According to the present embodiment, “load threshold value” is described as (ON threshold value, OFF threshold value). Note that according to the present embodiment, percentage (%) is used as the unit for “load threshold value”.

“Load threshold value” is determined for each application program. For example, a relatively high ON threshold value is set for an application program that accepts user operation such as scrolling or handwriting input at a high frequency, or an application program having a long duration from startup to shutdown, and a relatively low ON threshold value is set for other application programs.

“Monitoring target” specifies an application that monitors the CPU usage of a process. According to the present embodiment, “1” is assigned to an application that monitors the CPU usage of a process, and “0” is assigned to an application that does not monitor the CPU usage rate of a process. Note that according to the present embodiment, an application that operates in the foreground is a monitoring target, whereby “1” is recorded for Google Maps which is a foreground app, and “0” is assigned to a browser and calculator which are background apps.

“Previous measurement point-in-time” records the previous measurement point-in-time obtained from the timer unit 209. The “cumulative operating time up to previous measurement” records the cumulative operating time measured at the previous measurement point-in-time. Note that, according to the present embodiment, Tick (=10 ms) is used as the unit for “cumulative operating time up to previous measurement” and “previous measurement point-in-time”.

The application CPU core control information 302b dedicated to post-installation applications stores “program name”, “load threshold value”, “monitoring target”, “average duration”, “average CPU usage rate”, “previous measurement point-in-time”, “cumulative operating time up to previous measurement”, “application duration”, and “application load” for each application program.

“Monitoring target”, “previous measurement point-in-time”, and “cumulative operating time up to previous measurement” are similar to the application CPU core control information 302a of the pre-installation application.

Similar to the “load threshold value” of the pre-installation application, the “load threshold value” includes an ON threshold value (first load threshold value) and an OFF threshold value (second load threshold value). However, the “load threshold value” of a pre-installation application has default values (80, 50) set, but each time the application program ends, the default values are corrected based on the “average duration” and “average CPU usage rate”.

The “average duration” is the average of the time passed from the operation start to the operation end of the application. The “average CPU usage rate” is the average of the “CPU usage rate” during the period from the operation start to the operation end of the application. The “application duration time” is the time passed from the operation start of the application to the current point-in-time. The “application load” is a ratio of the actual operating time of the application, taken during the time passed from the operation start of the application to the current point-in-time. Note that according to the present embodiment, Tick (=10 ms) is used as the unit for “average duration” and “application duration”, and percentage (%) is used as the unit for “average CPU usage rate” and “application load”.

The “monitoring target” of the application CPU core control information 302 (302a, 302b) are updated by the application operation monitoring unit 203 for every foreground starting notification. The “previous measurement point-in-time” and “cumulative operating time up to previous measurement” of the application CPU core control information 302 (302a, 302b) are updated for every measurement by the application coordinating control unit.

CPU Control Information 303

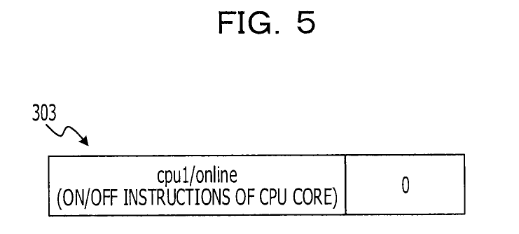

FIG. 5 is a schematic diagram of the CPU control information 303 according to the first embodiment.

As illustrated in FIG. 5, the CPU control information 303 stores “0” or “1” as the “cpu1/online” to determine the ON/OFF of the “core 1” 1012 of the CPU 101. According to the present embodiment, “0” is assigned to “OFF instructions” of the “core 1” 1012, and “1” is assigned to “ON instructions” of the “core 1” 1012. Therefore, in the case that “0” is registered to the “cpu1/online” of the CPU control information 303, the CPU state control unit 208 notifies the CPU frequency/state setting unit 206 of the “OFF instructions” for the “core 1” 1012. In the case that “1” is registered to the “cpu1/online” of the CPU control information 303, the CPU state control unit 208 notifies the CPU frequency/state setting unit 206 of the “ON instructions” for the “core 1” 1012. The “cpu1/online” of the CPU control information 303 is updated for each measurement by the application coordinating control unit 202.

System State Information 304

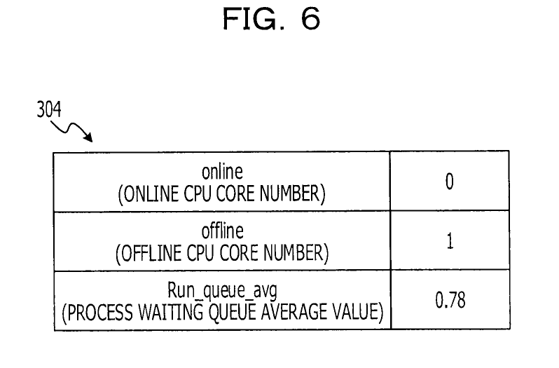

FIG. 6 is a schematic diagram of the system state information 304 according to the first embodiment.

As illustrated in FIG. 6, the system state information 304 stores an “Online (online CPU core number)”, “Offline” (offline CPU core number)”, and “Run_queue_avg (process waiting queue average value)”. “Online” stores a number of a running CPU core. “Offline” stores a number of a non-running CPU core. Accordingly, in the case that both of the “core 0” 1011 and “core 1” 1012 are running, “0” and “1” are recorded in “Online”, and nothing is recorded in “Offline”. In the case that only the “core 0” 1011 is running, “0” is recorded in “Online”, and “1” is recorded in “Offline”. “Run_queue_avg” is the average of the number of processes that are awaiting execution by the CPU 101. “Online”, “Offline”, and “Run_queue_avg” of the system state information 304 are updated for every measurement by the process/system managing unit 207.

Process Operation Information 305

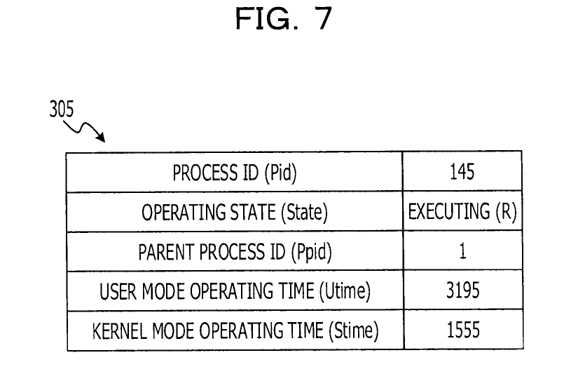

FIG. 7 is a schematic diagram of the process operating information 305 according to the first embodiment.

As illustrated in FIG. 7, the process operating information 305 is created for every process generated by the CPU 101, and stores “process ID (Pid)”, “operating state (State)”, “parent process ID (Ppid)”, “user mode operating time (Utime)”, and “kernel mode operating time (Stime)” for each process.

The “user mode operating time stores the operating time of the application programs such as applications and services. The “kernel mode operating time” is the operating time of the OS kernel that is associated with the process execution of the application programs such as applications and services. According to the present embodiment, the sum of “user mode operating time” and “kernel mode operating time” is the cumulative operating time of the application programs such as applications and services. Note that according to the present embodiment, “tick (=10 ms)” is used as the unit for “user mode operating time” and “kernel mode operating time”. The “process ID”, “operating state”, “parent process ID”, “user mode operating time”, and “kernel mode operating time” of the process operating information 305 are each updated for each measurement by the process/system managing unit 207.

CPU Core Control Processing

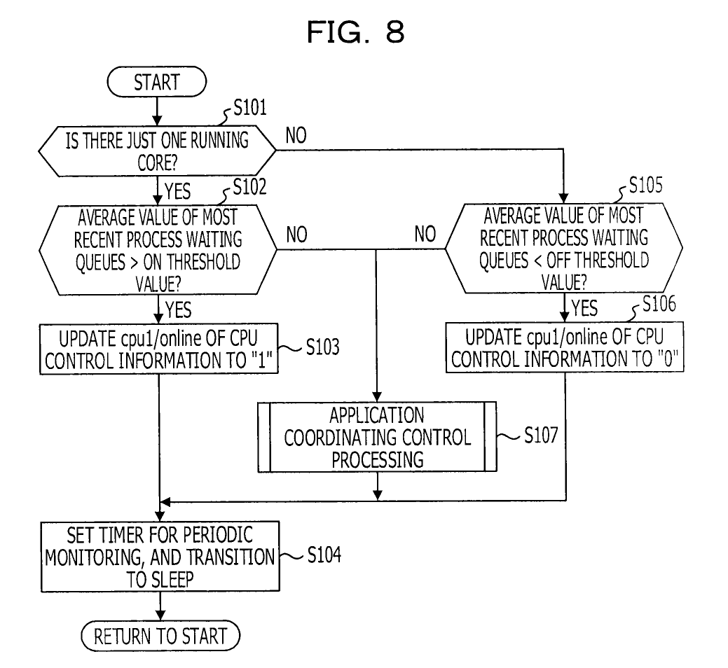

FIG. 8 is a flowchart of the CPU core control processing according to the first embodiment.

As illustrated in FIG. 8, the CPU core control determining unit 204 first references the system state information 304, and determines whether or not just the “core 0” 1011 is running (step S101). Specifically, the CPU core control determining unit 204 determines whether or not just the core number “0” of the “core 0” 1011 is registered in “Online” of the system state information 304.

Now, upon determining that just the “core 0” 1011 is running (Yes in step S101), the CPU core control determining unit 204 references the system state information 304, and determines whether or not the average value Q of the most recent process waiting queue is greater than a predetermined ON threshold value T_{ON} (step S102). Specifically, the CPU core control determining unit 204 determines whether or not the numerical value recorded in the “Run_queue_avg” of the system state information 304 is greater than the predetermined ON threshold value T_{ON}.

Now, upon determining that the average value Q of the most recent process waiting queue is greater than a predetermined ON threshold value T_{ON} (Yes in step S102), the CPU core control determining unit 204 updates “cpu1/online” of the CPU control information 303 to the core number “1” of the “core 1” 1012 (step S103). Upon updating “cpu1/online” to the core number “1” of the “core 1” 1012, ON instructions for the “core 1” 1012 are notified from the CPU state control unit 208 to the CPU frequency/state setting unit 206, whereby both the “core 0” 1011 and “core 1” 1012 are operating.

Next, the CPU core control determining unit 204 sets a timer for periodic monitoring, and transitions to a sleep state (step S104). The setting time of the timer is not particularly limited, but according to the present embodiment, is set as several tens of milliseconds. Upon fulfilling the setting time of the timer, the CPU core control determining unit 204 executes the processing of the CPU core control processing from the start.

On the other hand, if determination is not made that just the “core 0” 1011 is running (No in step S101), i.e. if determination is made that “core 1” 1012 is also running, the CPU core control determining unit 204 determines whether the average value Q of the most recent process waiting queue is smaller than a predetermined OFF threshold value T_{OFF} (step S105).

Now, upon determining that the average value Q of the most recent process waiting queue is smaller than a predetermined OFF threshold value T_{OFF} (Yes in step S105), the CPU core control determining unit 204 updates “cpu1/online” of the CPU control information 303 to “1” (step S106). Upon updating “cpu1/online” to “0”, OFF instructions for the “core 1” 1012 are notified from the CPU state control unit 208 to the CPU frequency/state setting unit 206, whereby only the “core 0” 1011 is operating.

Next, the CPU core control determining unit 204 sets a timer for periodic monitoring, and transitions to a sleep state (step S104). Upon fulfilling the setting time of the timer, the CPU core control determining unit 204 executes the processing of the CPU core control processing from the start.

In the case determination is not made that the average value Q of the most recent process waiting queue is greater than a predetermined ON threshold value T_{ON} (No in step S102), and in the case determination is not made that the average value Q of the most recent process waiting queue is smaller than a predetermined OFF threshold value T_{OFF} (No in step S105), the CPU core control determining unit 204 executes a callup for the application coordinating control unit 202 service as a sub-routine (step S107). That is to say, according to the present embodiment, for a case where the average value Q of the most recent process waiting queue is between the ON threshold value T_{ON} and OFF threshold value T_{OFF}, the details of the application coordinating control processing will be described later.

Also, upon ending the application coordinating control processing, the CPU core control determining unit 204 sets the timer for periodic monitoring, and transitions to a sleep state (step S104). Upon fulfilling the setting time of the timer, the CPU core control determining unit 204 executes the processing of the CPU core control processing from the start.

Here ends the description of the CPU core control processing flow.

Application Coordinating Control Processing

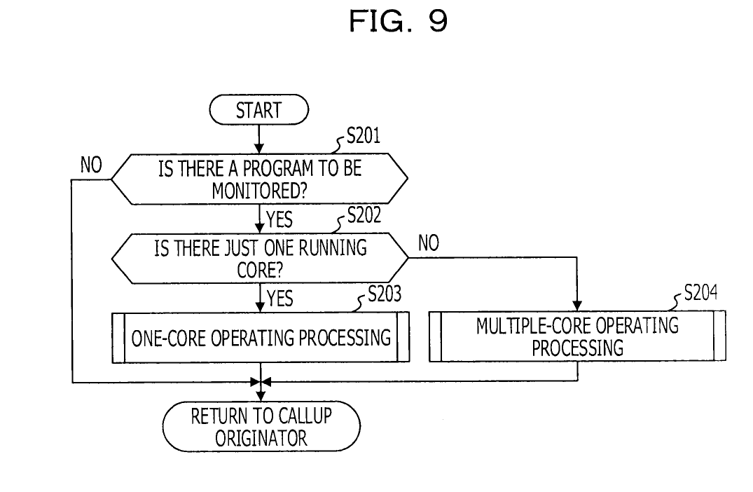

FIG. 9 is a flowchart describing the application coordinating control processing according to the first embodiment.

As described in FIG. 9, the application coordinating control unit 202 is started, based on a callup from a sub-routine during the CPU core control processing. The application coordinating control unit 202 first references the application CPU core control information 302 and determines whether or not the application program that is a monitoring target exists (step S201). Specifically, the application coordinating control unit 202 references the application CPU core control information 302 (both 302a and 302b) and determines whether or not the application program where “1” is registered in “monitoring target” exists.

Now, upon determining that an application program that is a monitoring target exists (Yes in step S201), the application coordinating control unit 202 references the system state information 304, and determines whether or not just the “core 0” 1011 is running (step S202). Specifically, the application coordinating control unit 202 determines whether or not just the core number “0” of the “core 0” 1011 is registered in “Online” of the system state information.

Now, upon determining that just the “core 0” 1011 is running (Yes in step S202), i.e. upon determining that the “core 1” 1012 is not running, the application coordinating control unit 202 executes a callup for one-core operating processing as a sub-routine (step S203). Details of the one-core operating processing will be described later.

Next, upon ending the one-core operating processing, the application coordinating control unit 202 executes processing for the callup originator of the application coordinating control processing.

On the other hand, if determination is not made that just the “core 0” 1011 is running (No in step S202), i.e. if determination is made that the “core 1” 1012 is also running, the application coordinating control unit 202 executes a callup for multiple-core operating processing as a sub-routine (step S204). Details of the multiple-core operating processing will be described later.

Next, upon ending the multiple-core operating processing, the application coordinating control unit 202 executes processing for the callup originator of the application coordinating control processing.

Here ends the description of the application coordinating control processing flow.

One-Core Operating Processing

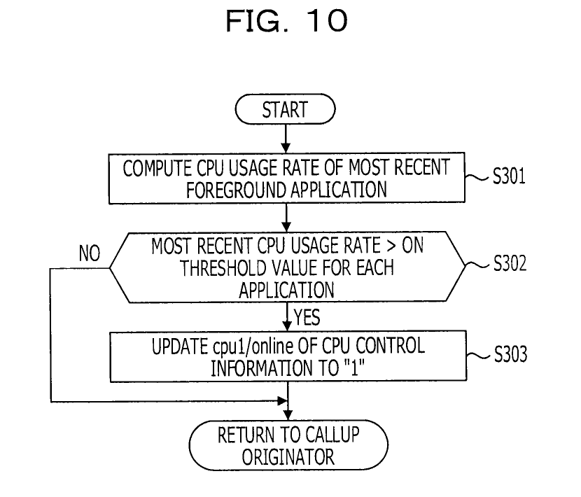

FIG. 10 is a flowchart describing one-core operating processing, according to the first embodiment.

Now, presuming that just the “core 0” 1011 of the CPU 101 is running, the determination of whether or not to start running the “core 1” 1012 will be described.

As illustrated in FIG. 10, the application coordinating control unit 202 starts the one-core operating processing, based on a callup from a sub-routine during the application coordinating control processing. In the one-core operating processing, the application coordinating control unit 202 first references the application CPU core control information 302 and process operation information 305, and computes the most recent CPU usage rate of the monitoring target application program, i.e. the foreground application (step S301). Note that the most recent CPU usage rate is the ratio of time in which the foreground application has actually operated from the previous measurement up to the current measurement, i.e. the ratio of time that the CPU 101 has actually been executing the foreground app, taken during the time passed from the previous measurement point-in-time to the current measurement point-in-time. The most recent CPU usage rate may be computed using the Expression (1) below, for example.

Most recent CPU usage rate=(cumulative operating time up to current measurement−cumulative operating time up to previous measurement)/current measurement point-in-time−previous measurement point-in-time) (1)

At this time, the application coordinating control unit 202 sets the sum of the “user mode operating time” and “kernel mode operating time” of the process operating information 305 of the monitoring target application program (foreground app) as the “cumulative operating time up to current measurement” in Expression (1), and the “cumulative operating time up to previous measurement” and “previous measurement point-in-time” recorded in the application CPU core control information 302 (302a or 302b) as the “cumulative operating time up to previous measurement” and “previous measurement point-in-time” in Expression (1), respectively.

Next, the application coordinating control unit 202 determines whether or not the most recent CPU usage rate of the foreground app is greater than the “ON threshold value” of the “load threshold value” determined for each foreground app (step S302).

Now, if the most recent CPU usage rate of the foreground app is determined to be greater than the “ON threshold value” of the “load threshold value” determined for each foreground app (Yes in step S302), the application coordinating control unit 202 updates the “cpu1/online” of the CPU control information 303 to the core number “1” of the “core 1” 1012 (step S303). Upon “cpu1/online” being updated to the core number “1” of the “core 1” 1012, ON instructions for the “core 1” 1012 is notified from the CPU state control unit 208 to the CPU frequency/state setting unit 206, and both the “core 0” 1011 and “core 1” 1012 are operated.

Next, following updating the “cpu1/online” of the CPU control information 303, the application coordinating control unit 202 executes processing for the callup originator of the one-core operating processing.

On the other hand, if the most recent CPU usage rate of the foreground app is not determined to be greater than the “ON threshold value” of the “load threshold value” determined for each foreground app (No in step S302), the application coordinating control unit 202 does not update the “cpu1/online” of the CPU control information 303, and executes processing for the callup originator of the one-core operating processing. That is to say, just the running of the “core 0” 1011 continues.

Here ends the description of the processing flow during one-core operation.

Multiple-Core Operating Processing

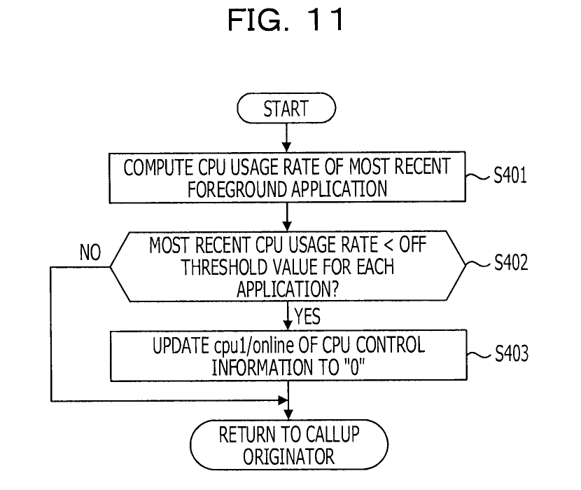

FIG. 11 is a flowchart describing multiple-core operating processing, according to the first embodiment.

Now, presuming that both the “core 0” 1011 and “core 1” 1012 of the CPU 101 are running, the determination of whether or not to stop running the “core 1” 1012 will be described.

As illustrated in FIG. 11, the application coordinating control unit 202 starts the multiple-core operating processing, based on a callup from a sub-routine during the application coordinating control processing. In the multiple-core operating processing, the application coordinating control unit 202 first references the application CPU core control information 302 and process operation information 305, and computes the most recent CPU usage rate of the foreground application (step S401). The most recent CPU usage rate may be computed similarly as with the one-core operating processing.

Next, the application coordinating control unit 202 determines whether or not the most recent CPU usage rate of the foreground app is smaller than the “OFF threshold value” of the “load threshold value” determined for each foreground app (step S402).

Now, if the most recent CPU usage rate of the foreground app is determined to be smaller than the “OFF threshold value” of the “load threshold value” determined for each foreground app (Yes in step S402), the application coordinating control unit 202 updates the “cpu1/online” of the CPU control information 303 to the core number “0” of the “core 0” 1011 (step S403). Upon “cpu1/online” being updated to the core number “0” of the “core 0” 1011, OFF instructions for the “core 1” 1012 is notified from the CPU state control unit 208 to the CPU frequency/state setting unit 206, whereby just the “core 0” 1011 is operated.

Next, following updating the “cpu1/online” of the CPU control information 303, the application coordinating control unit 202 executes processing for the callup originator of the multiple-core operating processing.

On the other hand, if the most recent CPU usage rate of the foreground app is not determined to be smaller than the “OFF threshold value” of the “load threshold value” determined for each foreground app (No in step S402), the application coordinating control unit 202 does not update the “cpu1/online” of the CPU control information 303, and executes processing for the callup originator of the multiple-core operating processing. That is to say, the running of both the “core 0” 1011 and “core 1” 1012 continues.

Here ends the description of the processing flow during multiple-core operation.

Application Operation Monitoring Processing

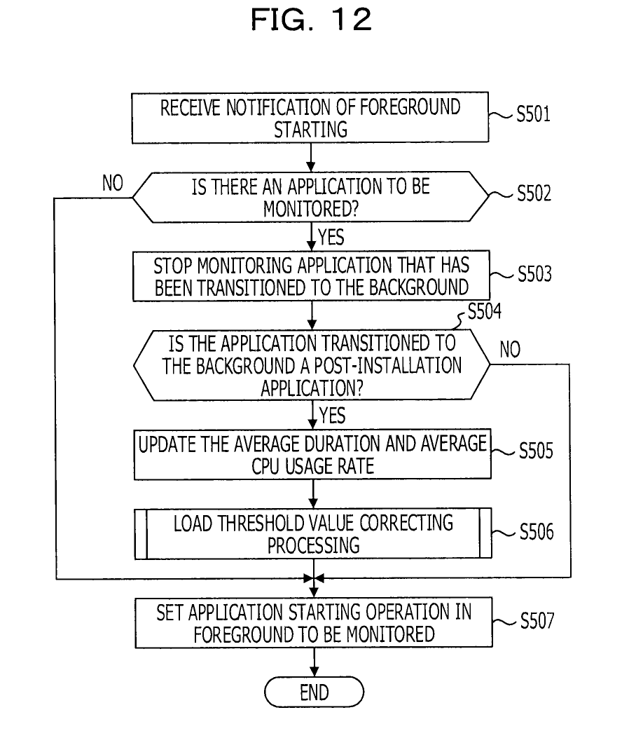

FIG. 12 is a flowchart describing application operation monitoring processing according to the first embodiment.

As illustrated in FIG. 12, upon receiving a foreground starting notification from the application execution managing unit 201 (step S501), the application operation monitoring unit 203 references the application CPU core control information 302, and determines whether or not a monitoring target application exists (step S502). Specifically, the application operation monitoring unit 203 references the application CPU core control information 302, and determines whether or not “0” is registered in “monitoring target”.

Now, if determination is made that a monitoring target application exists (Yes in step S502), the application operation monitoring unit 203 assumes that the application that had been a monitoring target up to that point has transitioned from foreground to background, and stops monitoring the application (step S503). Specifically, the application operation monitoring unit 203 updates the “monitoring target” in the application CPU core control information 302 from “1” to “0”.

Next, the application operation monitoring unit 203 determines whether or not the application transitioned to the background is a post-installation application that is installed afterwards (step S504).

Now, if determination is made that the application transitioned to the background is a post-installation application (Yes in step S504), the application operation monitoring unit 203 updates the “average duration” and “average CPU usage rate” of the application transitioned from foreground to background of the application CPU core control information 302 (step S505). Specifically, the application operation monitoring unit 203 updates the “average duration”, based on the “average duration” and “application duration” recorded in the application CPU core control information 302. Further, the application operation monitoring unit 203 updates the “average CPU usage rate”, based on the “average CPU usage rate” and “application load” recorded in the application CPU core control information 302 and the most recent “CPU usage rate” computed by the application coordinating control unit 202. That is to say, each time a monitoring target application is transitioned to the background, the “average duration” and “average CPU usage rate” of the application CPU core control information 302 are updated, based on past measurement results and immediately prior measurement results.

Next, the application operation monitoring unit 203 executes a callup for load threshold value correction processing as a sub-routine (step S506). Details of the load threshold value correction processing will be described later.

Next, upon ending the load threshold value correction processing, the application operation monitoring unit 203 sets an application having newly started operating in the foreground as a monitoring target (step S507). Specifically, the application operation monitoring unit 203 updates the “monitoring target” of the application having newly started operating in the foreground to “1”.

On the other hand, if determination is not made that a monitoring target application exists (No in step S502), or if determination is not made that the application for which monitoring is stopped is a post-installation application (No in step S504), the application operation monitoring unit 203 sets the application having newly started operating in the foreground as a monitoring target (step S507). Specifically, the application operation monitoring unit 203 sets “monitoring target” of the application having newly started operating in the foreground to “1”.

Here ends the description of the application operation monitoring processing flow.

Load Threshold Value Correcting Processing

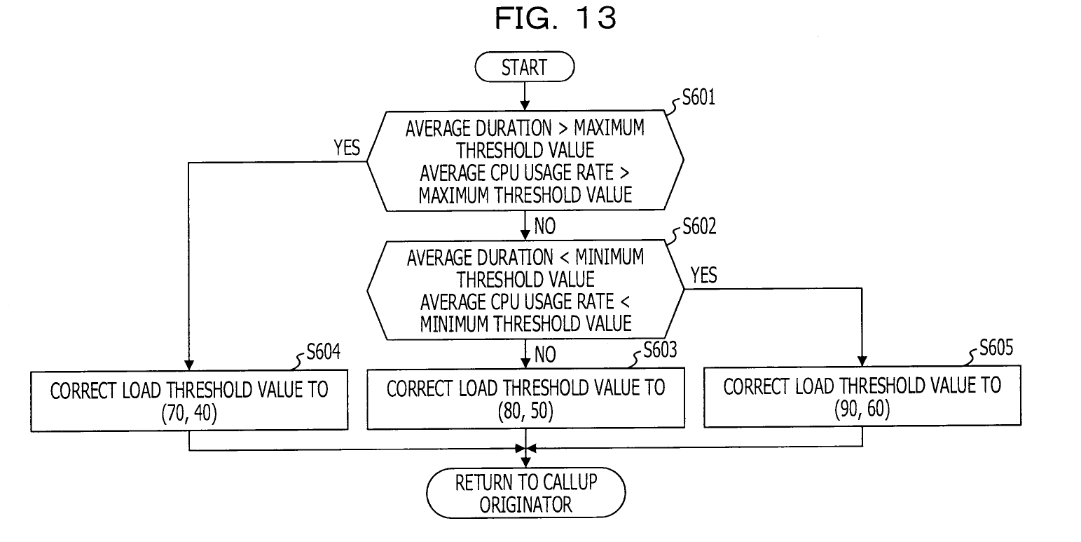

FIG. 13 is a flowchart describing load threshold value correcting processing, according to the first embodiment.

Descriptions will be made here under the presumption that the “load threshold value” of the application CPU core control information 302 is (80, 50).

As described in FIG. 13, the application operation monitoring unit 203 starts the load threshold value correcting processing, based on a callup from a sub-routine during the application operation monitoring processing. The application operation monitoring unit 203 first references the application CPU core control information 302b of the post-installation application in the load threshold correction processing, and determines whether or not the “average duration” of the post-installation application is greater than a predetermined maximum threshold value and the “average CPU usage rate” of the post-installation application is greater than a predetermined maximum threshold value (step S601).

Now, if determination is made that the “average duration” of the post-installation application is greater than a predetermined maximum threshold value and the “average CPU usage rate” of the post-installation application is greater than a predetermined maximum threshold value (Yes in step S601), the application operation monitoring unit 203 updates the “load threshold value” of the application CPU core control information 302 to (70, 40) for example (step S604). That is to say, the hurdle for turning ON the “core 1” 1011 (ON threshold value) is lowered, and the hurdle for turning OFF the “core 1” 1011 (OFF threshold value) is raised.

On the other hand, if determination is not made that the “average duration” of the post-installation application is greater than a predetermined maximum threshold value and the “average CPU usage rate” of the post-installation application is greater than a predetermined maximum threshold value (No in step S601), the application operation monitoring unit 203 determines whether the “average duration” of the post-installation application is smaller than a predetermined minimum threshold value and the “average CPU usage rate” of the post-installation application is smaller than a predetermined minimum threshold value (step S602).

Now, if determination is made that the “average duration” of the post-installation application is smaller than a predetermined minimum threshold value and the “average CPU usage rate” of the post-installation application is smaller than a predetermined minimum threshold value (Yes in step S602), the application operation monitoring unit 203 updates the “load threshold value” of the application CPU core control information 302 to (90, 60) for example (step S605). That is to say, the hurdle for turning ON the “core 1” 1011 (ON threshold value) is raised, and the hurdle for turning OFF the “core 1” 1011 (OFF threshold value) is lowered.

On the other hand, if determination is not made that the “average duration” of the post-installation application is smaller than a predetermined minimum threshold value and the “average CPU usage rate” of the post-installation application is smaller than a predetermined minimum threshold value (No in step S602), the application operation monitoring unit 203 updates the “load threshold value” of the application CPU core control information 302 to (80, 50) for example (step S603). Note that according to the present embodiment, the “load threshold value” is presumed to be (80, 50), so the “load threshold value” does not change.

Here ends the description of the load threshold correction processing flow.

According to the present embodiment, ON/OFF of the “core 1” 1012 of the CPU 101 is controlled using a “load threshold value” determined for each application program.

For example, for an application program that accepts user operations such as scrolling or handwriting input, a relatively low “ON threshold value” is used to determine whether the “core 1” 1012 of the CPU 101 is turned ON.

Therefore, when the CPU load increases in accordance with user operations, the “core 1” 1012 moves runs early, whereby the processing capability of the CPU 101 does not readily become deficient. Accordingly, quality decline of the result display of scrolling and handwriting input originating from deficiency in the processing capability of the CPU 101 may be suppressed.

Conversely, for an application program that does not accept much user operations such as scrolling or handwriting input, a relatively high “ON threshold value” is used to determine whether the “core 1” 1012 of the CPU 101 is turned ON.

Therefore, even though user operations such as scrolling and handwriting input that readily causes the CPU load to increase is not often accepted, the “core 1” 1012 may be inhibited from being run and unnecessary power consumption may be avoided.

Also, for an application program such as a browser or map which has a long duration from startup to shutdown, a relatively low “ON threshold value” is used to determine whether the “core 1” 1012 of the CPU 101 is turned ON.

The longer that the duration from application startup to shutdown is, the greater the opportunity is to accept user operations such as scrolling and handwriting input which readily increases the CPU load, but since the “core 1” 1012 runs early, when the user operation is actually accepted the processing capability of the CPU 101 does not readily become deficient. Accordingly, quality decline of the result display of scrolling and handwriting input originating from deficiency in the processing capability of the CPU 101 may be suppressed.

Conversely, for an application program such as a calculator which has a short duration from startup to shutdown, a relatively high “ON threshold value” is used to determine whether the “core 1” 1012 of the CPU 101 is turned ON.

Therefore, even though the application program is shut down shortly after startup, i.e. there is less opportunity to accept user operations such as scrolling and handwriting input which readily increases the CPU load, and the “core 1” 1012 may be inhibited from being run and unnecessary power consumption may be avoided.

Further, according to the present embodiment, default values are set for the “load threshold value” of the application that a user himself has installed after purchasing the portable terminal apparatus 100 (post-installation application), and when a post-installation application is transitioned from foreground to background, the “load threshold value” is updated with consideration for the operating situation in the foreground.

Therefore, even with a post-installation application of which the nature is not understood, depending on the use situation of the user, “load threshold value” according to the application program may become more realistic. Accordingly, for a post-installation application also, unnecessary power consumption and quality decline of the result display of scrolling and handwriting input originating from deficiency in the processing capability of the CPU 101 may be suppressed.

### Second Embodiment

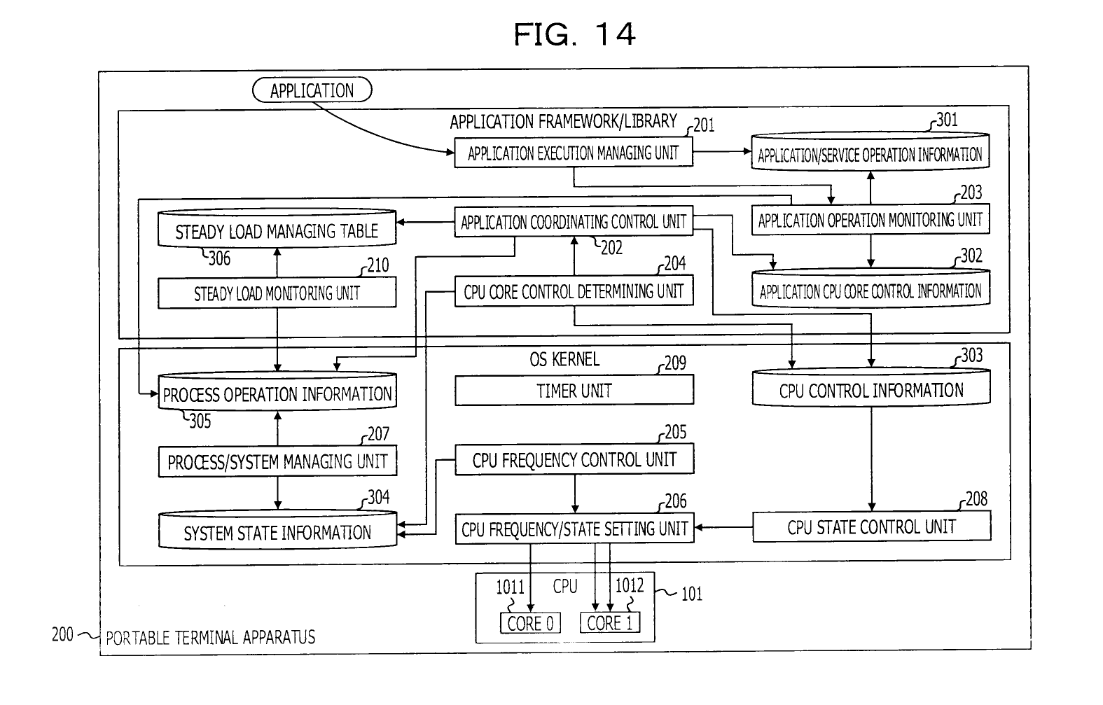

A portable terminal apparatus 200 according to a second embodiment will be described below with reference to FIGS. 14 through 19. According to the present embodiment, it is presumed that a service other than a foreground app operates in the background, and a steady CPU load which results from this service, i.e. a steady load, exists. In the case that a steady load exists, not only the most recent CPU usage rate of the foreground app but also the most recent CPU usage rate of the service is added, whereby the CPU load may be computed.

Note that similar to the most recent CPU usage rate of the previous application, the most recent CPU usage rate of the service is the average of time in which the service has actually operated from the previous measurement up to the current measurement, i.e. the ratio of time that the CPU 101 has actually been executing the service, taken during the time passed from the previous measurement point-in-time to the current measurement point-in-time.

Function Block of Portable Terminal Apparatus 200

FIG. 14 is a schematic diagram of a function block of the portable terminal apparatus 200 according to the second embodiment.

As illustrated in FIG. 14, the portable terminal apparatus 200 according to the present embodiment further has a steady load monitoring unit 210 and steady load managing table 306.

The steady load monitoring unit 210 and steady load managing table 306 are each realized by the CPU 101 executing a control program built into the Android application framework/library. Note that the steady load managing table 306 is configured in the supplemental memory 103.

The steady load monitoring unit 210 monitors, not applications that the user may operate on screen, but monitors the existence of use of a service that continuously operates in the background such as music playing or sensing processing, for example. Sensing processing may be sensing such as for position measurement or for a pedometer. Specifically, the steady load monitoring unit 210 updates “user mode operating time” and “kernel mode operating time” of the process operating information 305, and “operating state” and “duration” in the steady load managing table 306, based on the “starting threshold value”, “ending threshold value”, and “duration threshold value” of the steady load managing table 306.

The application coordinating control unit 202 periodically measures the operating state and CPU usage of the applications and services, and determines whether or not to increase/decrease the core of the CPU 101, based on the “load threshold value” of each foreground app. Specifically, the application coordinating control unit 202 references the steady load managing table 306, application CPU core control information 302, and process operating information 305, and computes the sum of “most recent CPU usage rate” of the foreground app and the “most recent CPU usage rate” of the service, as the most recent CPU load. Further, the application coordinating control unit 202 determines whether the “core 1” 1012 is ON/OFF, based on the sum of the “most recent CPU usage rate” of the foreground app and the “most recent CPU usage rate” of the service and the “load threshold value” determined for each foreground app, and records “0” or “1” in the “cpu1/online” of the CPU control information 303.

Steady Load Managing Table 306

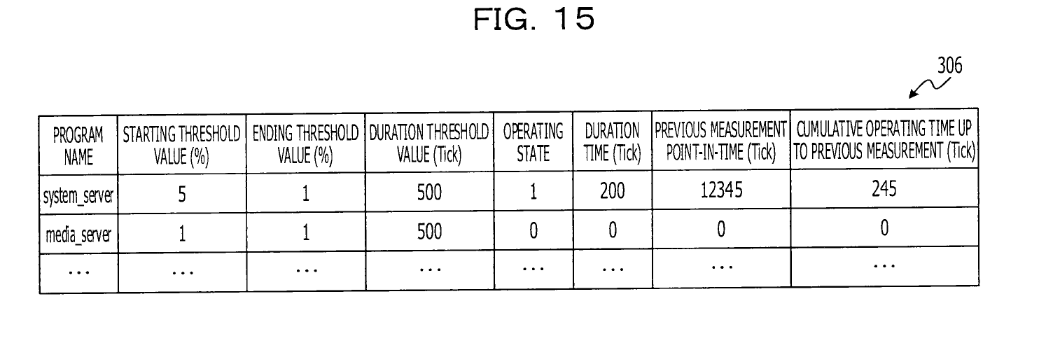

FIG. 15 is a schematic diagram of the steady load managing table 306 according to the second embodiment.

As illustrated in FIG. 15, the steady load managing table 306 stores a “program name”, “starting threshold value”, “ending threshold value”, “duration threshold value”, “operating state”, “duration”, “previous measurement point-in-time”, and “cumulative operating time up to previous measurement”.

Note that the application program registered in the steady load managing table 306 is an application program that constantly operates in the background, i.e. a service, based on requests from applications such as a system server, media server, sensing application, and so forth.

“Operating state” is used to determine whether or not a steady load exists. “stopped”, “starting”, “operating”, and “ending” are defined as “operating states”, “0” is assigned to “stopped”, “1” to “starting”, “2” to “operating”, and “3” to “ending”.

“Stopped” is an operating state where a steady load does not exist. “Operating” is an operating state where a steady load does exist. “Starting” is a transitioning state from “stopped” to “operating”, and specifically is an operating state that determines whether or not to deem that a steady load exists. “Ending” is a transitioning state from “operating” to “stopped”, and specifically is an operating state that determines whether or not to deem that a steady load has disappeared.

“Duration” is the time passed from transitioning to each “operating state”. For example, if the “operating state” is “operating”, the “duration” is the “operating” time which has passed that is measured with the transition point-in-time from “starting” to “operating” as the origin point.

“Starting threshold value” is used to start the determination of whether or not a steady load exists. Details will be described later, but in the case that the most recent CPU usage rate of the monitoring target service is greater than the “starting threshold value”, the steady load monitoring unit 210 starts determining whether or not a steady load exists.

“Ending threshold value” is used to start the determination of whether or not a steady load has disappeared. Details will be described later, but in the case that the most recent CPU usage rate of the monitoring target service is smaller than the “ending threshold value”, the steady load monitoring unit 210 starts determining whether or not a steady load has disappeared. “Duration threshold value” is used to determine whether or and a steady load exists and to determine whether or not a steady load has disappeared. Details will be described later, but in the case that the “operating state” of the monitoring target service is “starting”, i.e. in the case that “duration” is greater than “duration threshold value”, the steady load monitoring unit 210 determines that a steady load exists. Also, in the case that the “operating state” of the monitoring target service is “ending”, i.e. in the case that “duration” is greater than “duration threshold value”, the steady load monitoring unit 210 determines that a steady load has disappeared.

Note that “starting threshold value”, “ending threshold value”, and “duration threshold value” are each predetermined. According to the present embodiment, percentage (%) is used as the unit for “starting threshold value” and “ending threshold value”, and Tick (=10 ms) is used as the unit for “duration threshold value” and “duration”.

“Previous measurement point-in-time” and “cumulative operating time up to previous measurement” are each similar to “previous measurement point-in-time” and “cumulative operating time up to previous measurement” of the application CPU core control information 302.

“Operating state” and “duration” of the steady load managing table 306 are updated by the steady load monitoring unit 210, and “previous measurement point-in-time” and “cumulative operating time up to previous measurement” are updated by the application coordinating control unit 202.

Application Coordinating Control Processing

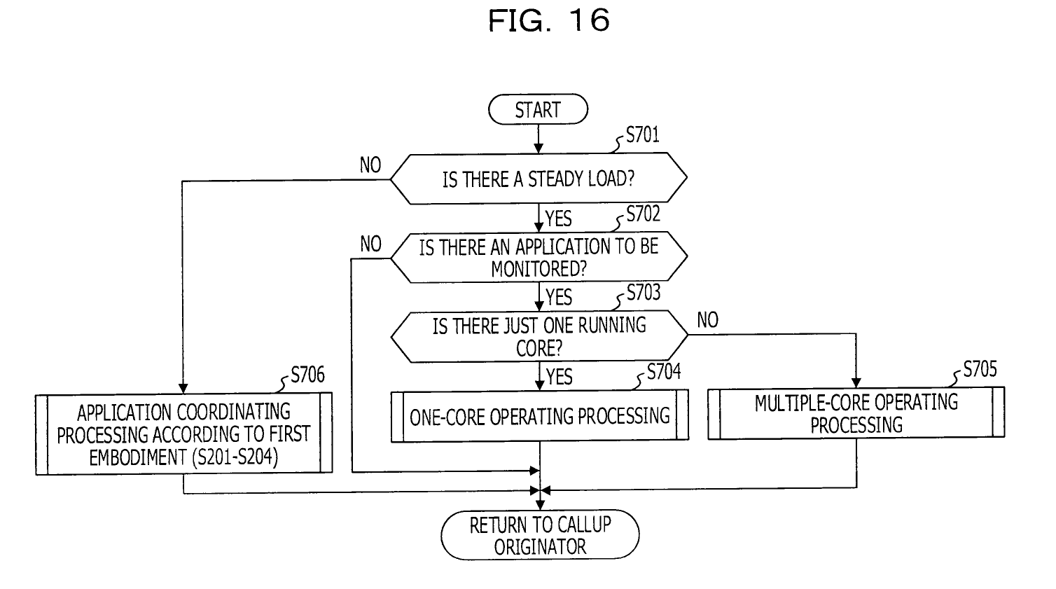

FIG. 16 is a flowchart illustrating an application coordinating control processing according to the second embodiment.

As illustrated in FIG. 16, the application coordinating control unit 202 is started, based on a callup from a sub-routine during the CPU core control processing. The application coordinating control unit 202 first references the steady load managing table 306 and determines whether or not a steady load exists (step S701). Specifically, the application coordinating control unit 202 references the steady load managing table 306 and determines whether or not an application program (service) where “2” is registered in “operating state” exists. Note that details of the determination of whether or not a steady load exists will be described later.

Now, upon determining that a steady load exists (Yes in step S701), the application coordinating control unit 202 references the application CPU core control information 302, and determines whether or not an application program (app) that is a monitoring target exists (step S702). Specifically, the application coordinating control unit 202 references the application CPU core control information 302, and determines whether or not an application program (app) having “1” registered in “monitoring target” exists.

Now, upon determining that a monitoring target app exists (Yes in step S702), the application coordinating control unit 202 references the system state information 304, and determines whether or not just “core 0” 1011 is running (step S703). Specifically, the application coordinating control unit 202 determines whether or not just the core number “0” of the “core 0” 1011 is registered in “Online” of the system state information 304.

Now, upon determining that just the “core 0” 1011 is running (Yes in step S703), i.e. upon determining that the “core 1” 1012 is not running, the application coordinating control unit 202 executes a callup for one-core operating processing as a sub-routine (step S704). Details of the one-core operating processing will be described later.

Next, upon ending the one-core operating processing, the application coordinating control unit 202 executes processing for the callup originator of the application coordinating control processing.

On the other hand, if determination is not made that just the “core 0” 1011 is running (No in step S703), i.e. if determination is made that the “core 1” 1012 is also running (No in step S703), the application coordinating control unit 202 executes a callup for multiple-core operating processing as a sub-routine (step S705). Details of the multiple-core operating processing will be described later.

Next, upon ending the multiple-core operating processing, the application coordinating control unit 202 executes processing for the callup originator of the application coordinating control processing.

Note that if determination is not made that a steady load exists (No in step S701), the application coordinating control unit 202 executes the application coordinating control processing (steps S201 through 5204) according to the first embodiment (step S706).

Here ends the description of the application coordinating control processing flow.

One-Core Operating Processing

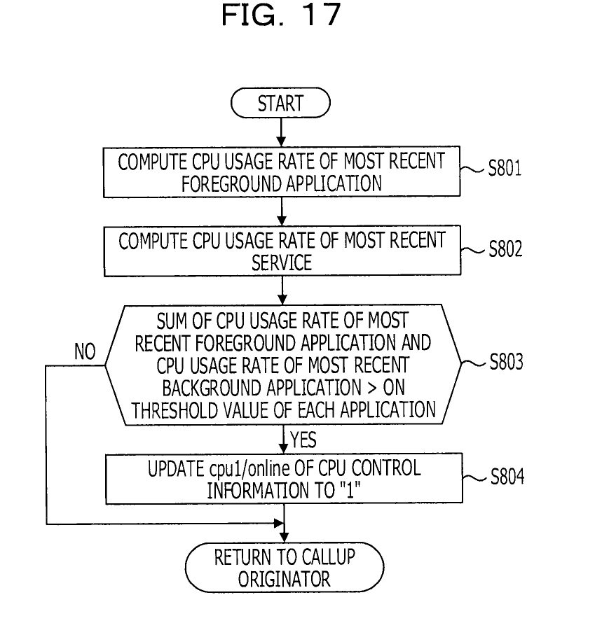

FIG. 17 is a flowchart illustrating one-core operating processing according to the second embodiment.

As illustrated in FIG. 17, the application coordinating control unit 202 starts the one-core operating processing, based on a callup from a sub-routine during the application coordinating control processing. In the one-core operating processing, the application coordinating control unit 202 first references the application CPU core control information 302 and process operation information 305, and computes the most recent CPU usage rate of the monitoring target application program, i.e. the foreground application (step S801). Note that the most recent CPU usage rate is the ratio of time in which the foreground application has actually operated from the previous measurement up to the current measurement, i.e. the ratio of time that the CPU 101 has actually been executing the foreground app, taken during the time passed from the previous measurement point-in-time to the current measurement point-in-time. The most recent CPU usage rate may be computed using the Expression (1) described above, for example.

At this time, the application coordinating control unit 202 sets the sum of the “user mode operating time” and “kernel mode operating time” of the process operating information 305 of the monitoring target application program (foreground app) as the “cumulative operating time up to current measurement” in Expression (1), the current point-in-time obtained from the timer unit 209 as the “current measurement point-in-time” of the Expression (1), and the “cumulative operating time up to previous measurement” and “previous measurement point-in-time” recorded in the application CPU core control information 302 (302a or 302b) as the “cumulative operating time up to previous measurement” and “previous measurement point-in-time” in Expression (1), respectively.

Next, the application coordinating control unit 202 references the steady load managing table 306 and processing operating information 305, and computes the most recent CPU usage rate of the application program causing the steady load to occur, i.e. the service (step S802). The most recent CPU usage rate of the service may also be computed by the above-described Expression (1).

At this time, the application coordinating control unit 202 sets the sum of the “user mode operating time” and “kernel mode operating time” of the process operating information 305 of the service causing the steady load to occur as the “cumulative operating time up to current measurement” in Expression (1), the current point-in-time obtained from the timer unit 209 as the “current measurement point-in-time” of the Expression (1), and the “cumulative operating time up to previous measurement” and “previous measurement point-in-time” recorded in the steady load managing table 306 “cumulative operating time up to previous measurement” and “previous measurement point-in-time” of the Expression (1).

Next, the application coordinating control unit 202 determines whether or not the sum of the most recent CPU usage rate of the foreground app and the most recent CPU usage rage of the service causing the steady load to occur (the most recent CPU load) is greater than the “ON threshold value” of the “load threshold value” determined for each application program (step S803).

Now, if the sum of the most recent CPU usage rate of the foreground app and the most recent CPU usage rate of the service causing the steady load to occur is determined to be greater than the “ON threshold value” of the “load threshold value” determined for each application program (Yes in step S803), the application coordinating control unit 202 updates the “cpu1/online” of the CPU control information 303 to the core number “1” of the “core 1” 1012 (step S804). Upon “cpu1/online” being updated to the core number “1” of the “core 1” 1012, ON instructions for the “core 1” 1012 are notified from the CPU state control unit 208 to the CPU frequency/state setting unit 206, and both the “core 0” 1011 and “core 1” 1012 are operated.

Next, following updating the “cpu1/online” of the CPU control information 303, the application coordinating control unit 202 executes processing for the callup originator of the one-core operating processing.

On the other hand, if t the sum of the most recent CPU usage rate of the foreground app and the most recent CPU usage rate of the service causing the steady load to occur is not determined to be greater than the “ON threshold value” of the “load threshold value” determined for each application program (No in step S803), the application coordinating control unit 202 does not update the “cpu1/online” of the CPU control information 303, and executes processing for the callup originator of the one-core operating processing. That is to say, just the running of the “core 0” 1011 continues.

Here ends the description of the flow of one-core operating processing.

Multiple-Core Operating Processing

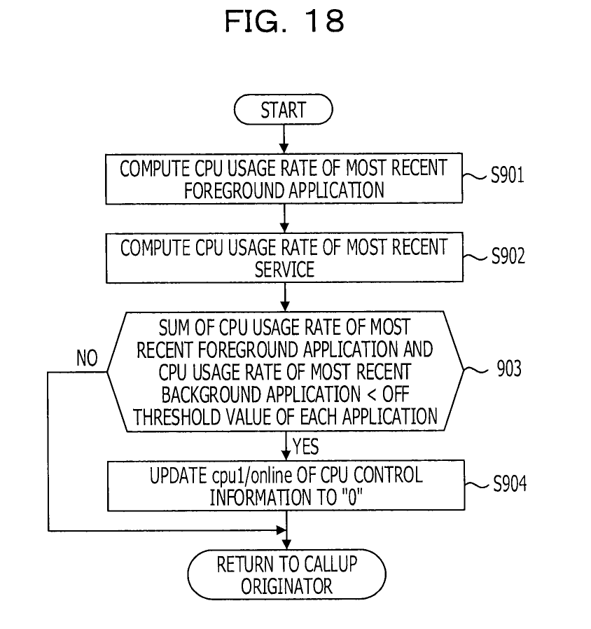

FIG. 18 is a flowchart describing multiple-core operating processing according to the second embodiment.

As illustrated in FIG. 18, the application coordinating control unit 202 starts the multiple-core operating processing, based on a callup from a sub-routine during the application coordinating control processing. In the multiple-core operating processing, the application coordinating control unit 202 first references the application CPU core control information 302 and process operation information 305, and computes the most recent CPU usage rate of the foreground application (average operating load) (step S901). The most recent CPU usage rate may be computed similarly as with the one-core operating processing.

Next, the application coordinating control unit 202 references the steady load managing table 306 and process operating information 305, and computes the most recent CPU usage rate of the service that is causing the steady load to occur (average steady load) (step S902). The most recent CPU usage rate may be computed similarly as with the one-core operating processing.

Next, the application coordinating control unit 202 determines whether or not the sum of the most recent CPU usage rate of the foreground app and the most recent CPU usage rate of the service that is causing the steady load to occur is smaller than the “OFF threshold value” of the “load threshold value” determined for each application program (step S903).

Now, if the sum of the most recent CPU usage rate of the foreground app and the most recent CPU usage rate of the service that is causing the steady load to occur is determined to be smaller than the “OFF threshold value” of the “load threshold value” determined for each application program (Yes in step S903), the application coordinating control unit 202 updates the “cpu1/online” of the CPU control information 303 to the core number “0” of the “core 0” 1011 (step S904). Upon “cpu1/online” being updated to the core number “0” of the “core 0” 1011, OFF instructions for the “core 1” 1012 is notified from the CPU state control unit 208 to the CPU frequency/state setting unit 206, whereby just the “core 0” 1011 is operated.

Next, following updating the “cpu1/online” of the CPU control information 303, the application coordinating control unit 202 executes processing for the callup originator of the multiple-core operating processing.

On the other hand, if the sum of the most recent CPU usage rate of the foreground app and the most recent CPU usage rate of the service that is causing the steady load to occur is not determined to be smaller than the “OFF threshold value” of the “load threshold value” determined for each foreground app (No in step S903), the application coordinating control unit 202 does not update the “cpu1/online” of the CPU control information 303, and executes processing for the callup originator of the multiple-core operating processing. That is to say, the running of both the “core 0” 1011 and “core 1” 1012 continues.

Here ends the description of the processing flow during multiple-core operation.

Steady Load Monitoring Processing

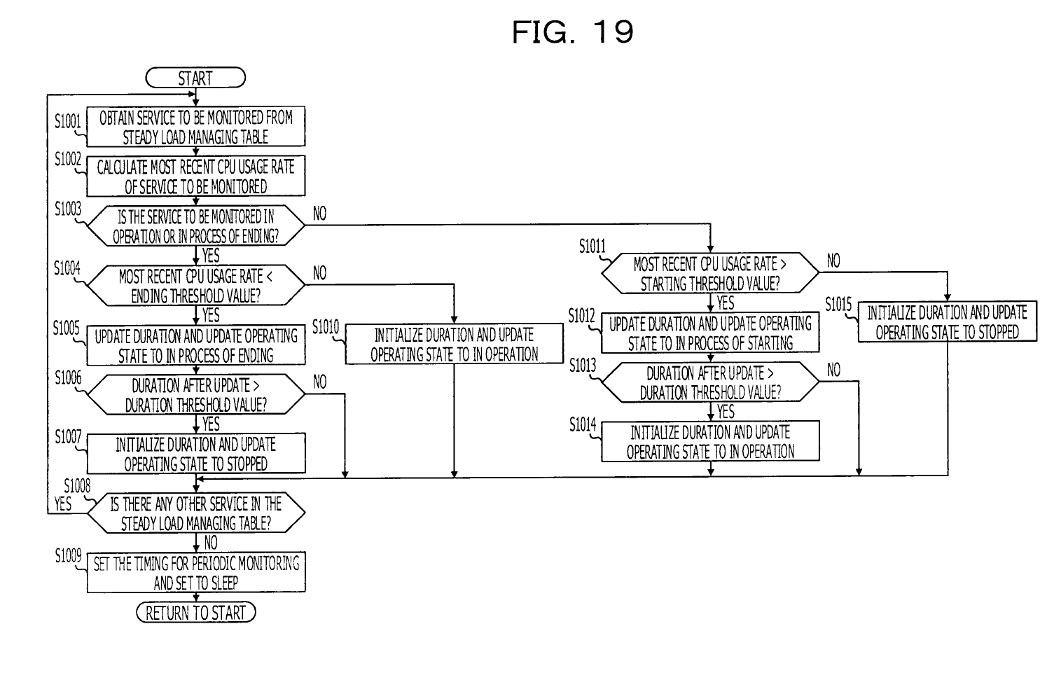

FIG. 19 is a flowchart describing the steady load monitoring processing according to the second embodiment.

As illustrated in FIG. 19, the steady load monitoring unit 210 first references the steady load managing table 306, and obtains a monitoring target service (step S1001).

Next, the steady load monitoring unit 210 references the steady load managing table 306 and processing operating information 305, and computes the most recent CPU usage rate of the monitoring target service (step S1002). The most recent. CPU usage rate may be computed by the above-described Expression (1), for example.

At this time, the steady load monitoring unit 210 sets the sum of the “user mode operating time” and “kernel mode operating time” of the process operating information 305 of the monitoring target service as the “cumulative operating time up to current measurement” in Expression (1), the current point-in-time obtained from the timer unit 209 as the “current measurement point-in-time” of the Expression (1), and the “cumulative operating time up to previous measurement” and “previous measurement point-in-time” recorded in the steady load managing table 306 as the “cumulative operating time up to previous measurement” and “previous measurement point-in-time” in Expression (1), respectively.

Next, the steady load monitoring unit 210 references the steady load managing table 306, and determines whether or not the monitoring target service is “operating” or “ending” (step S1003). Specifically, the steady load monitoring unit 210 references the steady load managing table 306, and determines whether or not “2” which means “operating” or “3” which means “ending” is recorded in the “operating state”. For confirmation purposes, “operating” is the operating state in which a steady load exists, and “ending” is the operating state in which a transition state from “operating” to “stopped”, i.e. ending confirmation of the steady load, is executed.

Now, if determination is made that the monitoring target service is “operating” or “ending” (Yes in step S1003), the steady load managing unit 210 references the steady load managing table 306, and determines whether or not the most recent CPU usage rate is smaller than the “ending threshold value” (step S1004).

Now, if determination is made that the most recent CPU usage rate of the monitoring target service is smaller than the “ending threshold value” (Yes in step S1004), the steady load managing unit 210 updates the “duration” in the steady load managing table 306, and updates the “operating state” in the steady load table 306 to “ending” (step S1005). Specifically, the steady load managing unit 210 adds the time passed from the previous measurement to the current measurement to the “duration” recorded in the steady load managing table 306, and updates this as a new “duration”, while updating the “operating state” of the steady load managing table 306 to “3” which means “ending”. For confirmation purposes, “duration” is the time passed since transitioning to each “operating state”. For example, if the “operating state” is “operating”, the “duration” is the “operating” time passed which is measured using the transition point-in-time from “starting” to “operating” as the origin point.

Next, the steady load managing unit 210 references the steady load managing table 306, and determines whether or not “duration” is greater than “duration threshold value” (step S1006).

Now, if determination is made that “duration” is greater than “duration threshold value” (Yes in step S1006), the steady load managing unit 210 initializes (updates to initial value) the “duration” of the steady load managing table 306 for determination the next time and thereafter, while updating the “operating state” to “stopped” (step S1007). Specifically, the steady load managing unit 210 updates the “duration” of the steady load managing table 306 to the initial value of “0”, while updating the “operating state” of the steady load managing table 306 to “0” which means “stopped”.

Next, the steady load managing unit 210 references the steady load managing table 306, and determines whether or not another service exists (step S1008).

Now, if determination is made that another service does not exist (Yes in step S1008), the steady load managing unit 210 sets a timer for periodic monitoring, and transitions to a sleep state (step S1009). The setting time of the timer is not particularly limited, but according to the present embodiment, is set as several tens of milliseconds. Upon fulfilling the setting time of the timer, the steady load managing unit 210 executes the steady load monitoring processing from the start.

On the other hand, if determination is not made that another service does not exist (No in step S1008), i.e. if determination is made that another service does exist, the steady load managing unit 210 executes the steady load monitoring processing from the start, with the service that exists as a monitoring target.

On the other hand, if determination is not made that the most recent CPU usage rate of the monitoring target service is smaller than an “ending threshold value” (No in step S1004), the steady load managing unit 210 initializes (updates to initial values) the “duration” of the steady load managing table 306 (step S1010), and also updates the “operating state” of the steady load managing table 306 to “operating”. Specifically, the steady load managing unit 210 updates the “duration” of the steady load managing table 306 to the initial value of “0”, while updating the “operating state” to “2” which means “operating”.

Next, the steady load managing unit 210 references the steady load managing table 306, and determines whether or not another service exists (step S1008).

Also, if determination is not made that the monitoring target service is “operating” or “ending” (No in step S1003), i.e. if determination is made that the monitoring target service is “stopped” or “starting”, the steady load managing unit 210 references the steady load managing table 306, and determines whether or not the most recent CPU usage rate is greater than “starting threshold value” (step S1011). For confirmation purposes, “stopped” is an operating state where a steady load does not exist, and “starting” is a transition state from “stopped” to “operating”, i.e. an operating state of executing the start confirmation of the steady load.

Now, if determination is made that the most recent CPU usage rate of the monitoring target service is greater than a “starting threshold value” (Yes in step S1011), the steady load managing unit 210 updates the “duration” of the steady load managing table 306, while updating the “operating state” of the steady load managing table 306 to “starting” (step S1012). Specifically, the steady load managing unit 210 adds the time passed from the previous measurement to the current measurement to the “duration” recorded in the steady load managing table 306, and updates this as a new “duration”, while updating the “operating state” of the steady load managing table 306 to “1” which means “starting”.

Next, the steady load managing unit 210 references the steady load managing table 306, and determines whether or not “duration” is greater than “duration threshold value” (step S1013).

Now, if determination is made that “duration” is greater than “duration threshold value” (Yes in step S1013), the steady load managing unit 210 initializes (updates to initial value) the “duration” of the steady load managing table 306 for determination the next time and thereafter, while updating the “operating state” to “operating” (step S1014). Specifically, the steady load managing unit 210 updates the “duration” of the steady load managing table 306 to the initial value of “0”, while updating the “operating state” of the steady load managing table 306 to “2” which means “operating”.

Next, the steady load managing unit 210 references the steady load managing table 306, and determines whether or not another service exists (step S1008).

On the other hand, if determination is not made that the most recent CPU usage rate of the monitoring target service is greater than a “starting threshold value” (No in step S1011), the steady load managing unit 210 initializes (updates to initial values) the “duration” of the steady load managing table 306, while updating the “operating state” of the steady load managing table 306 to “stopped” (step S1015). Specifically, the steady load managing unit 210 updates the “duration” of the steady load managing table 306 to the initial value of “0”, while updating the “operating state” of the steady load managing table 306 to “0” which means “stop”.

Next, the steady load managing unit 210 references the steady load managing table 306, and determines whether or not another service exists (step S1008).

Here ends the description of the steady load monitoring processing flow.

According to the present embodiment, in the case that a service other than the foreground app that causes a steady load to occur, ON/OFF of the “core 1” 1012 of the CPU 101 is determined, using the sum of the most recent CPU usage rate of the foreground app and the most recent CPU usage rate of the service as the CPU load.

Therefore, even in the case that the service causing a steady load to occur is operating in the background, ON/OFF of the “core 1” 1012 of the CPU 101 may be correctly controlled.

Further, even in a case that the CPU load increases suddenly as a result of screen operations of a foreground app, services desired to continuously operate, such as music playing or sensing processing, will not be influenced. For example, skipped sounds while playing music or breaks in sensing may be suppressed.

Note that according to the present embodiment, the sum of the most recent CPU usage rate of the foreground app and the most recent CPU usage rate of a service causing a steady load to occur is defined as the CPU load, but the embodiments of the present disclosure are not limited to this. For example, in the case that a background application is causing a steady load to occur, the sum of the most recent CPU usage rate of the foreground app and the most recent CPU usage rate of the background app may be defined as the CPU load.

Further, a steady load may occur as a result of both a background app and a service operating, may occur as a result of multiple background apps operating, or may occur as a result of multiple services operating.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of controlling an information processing apparatus, the method comprising:
detecting a first application program of which an execution result is displayed;
obtaining a parameter correlating to the first application program; and
determining, by a processor, the number of cores to be run in a CPU on a basis of the parameter.

2. The method according to claim 1, further comprising:
recording cumulative time for which the first application program has been executed in a unit of time from a startup to an ending of the first application program; and
varying the parameter on a basis of the cumulative time.

3. The method according to claim 1, further comprising:
recording amount of time elapsed from a startup to an ending of the first application program; and
varying the parameter on a basis of the amount of time.

4. The method according to claim 1,
wherein the determining includes
obtaining load of the CPU; and
determining the number of the cores to be run on a basis of the load and the parameter.

5. The control according to claim 4,
wherein the parameter include a first load threshold value used to increase the number of cores to be run, and
the determining includes increasing the number of cores to be run when the load is equal to or greater than the first load threshold value.

6. The method according to claim 4,
wherein the parameter include a second load threshold value used to decrease the number of cores to be run, and
the determining includes decreasing the number of cores to be run when the load is equal to or smaller than the second load threshold value.

7. The method according to claim 4, further comprising:
detecting a second application program running other than the first application program; and
calculating the load on a basis of time for which the first application program is executed in a unit of time and time for which the second application program is executed in a unit of time.

8. The method according to claim 1,
wherein the detecting includes detecting the first application program for causing the information processing apparatus to display an image to be scrolled.

9. The method according to claim 1,
wherein the detecting includes detecting the first application program for causing the information processing apparatus to receive input operation to the first application program by a user.

10. A medium that stores a program for causing an information processing apparatus to execute a process, the process comprising:
detecting an application program of which an execution result is displayed;
obtaining a parameter correlating to the application program; and
determining the number of cores to be run in a CPU on a basis of the parameter.

11. An information processing apparatus comprising:
a processor configured to:
detect an application program of which an execution result is displayed;
obtain a parameter correlating to the application program; and
determine the number of cores to be run in a CPU on a basis of the parameter.

12. A device comprising:
a circuit that configured to:
input information correlating to an application program of which an execution result is displayed;
obtain a parameter correlating to the application program; and
output information on the number of cores to be run in a CPU on a basis of the parameter.
